(19) United States
(12) Patent Application Publication
(10) Pub. No.: US 2024/0311734 A1
(43) Pub. Date: Sep. 19, 2024

(54) HARVEST YIELD PREDICTION METHODS AND SYSTEM

(71) Applicant: Bitstrata Systems Inc., Saskatoon (CA)

(72) Inventor: Ian Robert Meier, Saskatoon (CA)

(73) Assignee: Bitstrata Systems Inc., Saskatoon, SK (CA)

(21) Appl. No.: 18/577,973

(22) PCT Filed: Jul. 14, 2022
(86) PCT No.: PCT/CA2022/051097

§ 371 Date: Jan. 9, 2024

Related U.S. Application Data
(60) Provisional application No. 63/222,185, filed on Jul. 15, 2021.

(51) Int. Cl. G06Q 10/0637; G06Q 50/02

(52) U.S. Cl. CPC G06Q 10/06375; G06Q 50/02

(57) ABSTRACT

Systems and methods for yield prediction for a field using spatial data representing yield throughout the field and multiple measurements of actual yield obtained from field regions during harvesting of the field. A yield model is generated based on the spatial data and the multiple measurements of actual yield. The yield model is used to determine information related to yield in the field.

### CROSS REFERENCE TO RELATED APPLICATIONS

This application claims the benefit of the filing date under 35 U.S.C. § 119(e) of U.S. Provisional Application Ser. No. 63/222,185 filed on Jul. 15, 2021, the entire disclosure of which is incorporated by reference in its entirety.

### FIELD

Embodiments relate to systems and method for harvest yield prediction.

### BACKGROUND

Measuring crop yield spatially within a harvested field is a fundamental component of a precision agriculture program. This information is generally collected and stored as a set of georeferenced points, where each location is accompanied by data representative of the yield at that location. This data is typically organized by field, and the set of georeferenced yield points for a given field is generally referred to as a yield map. Because this map represents the variability of yield within a field, it is one of the primary inputs used for generating a variable-rate prescription map in the subsequent seeding or planting season.

Yield maps are typically produced with a device called a yield monitor which produces an instantaneous measurement of the yield associated with a particular location at which the measurement was performed by the device. The result is a dataset providing a two-dimensional representation of the yield. Yield monitors may operate on a mass or volumetric basis, and generally rely on careful calibration for accuracy. The calibration process is often complicated due, at least in part, to the non-linearity and crop-dependent behavior of sensors, such as force plates or volumetric sensors, to which yield monitors typically connect. To rectify such calibration issues, a common practice is to weigh all harvested crop with another scale, such as with a grain cart, and use these other measurements as a means for post-calibrating a yield map. This is often performed by linearly scaling each data point of the yield map such that the total quantity of grain represented by the map matches that measured by the scale. This method, however, does not account for the non-linearity of the yield monitor or any mismatch between multiple harvesting machines that operated in the same field, where the latter issue may be recognized by the appearance of visible stripes in a visualization of the composite yield map resulting from the discontinuities.

Solutions to harvester calibration mismatch often require manual intervention, where an experienced user or precision agriculture consultant manually adjusts the scaling factor for each harvesting machine such that no visible striping remains. As this is a visual process, it may cause the accuracy of the corrected yield to be highly variable based on the opportunity for human error. Some attempts to automate this process have been made, for instance, by simply shifting the data such that the averages of each harvester match, which assumes that the average yield harvested by each machine is equal. As the yield may vary significantly throughout a field, this assumption is generally not valid, and the approach further avoids any attempt to bring the variability of the yield data from each machine into alignment. This is because a machine calibrated to produce higher yields than another machine will generate data that is both higher in average yield and in variability, so a simple shift in the average does not adjust the variability itself. Given that the primary purpose of a yield monitor is to monitor the variability of the yield throughout the field, it is important to have this accurately represented.

### BRIEF DESCRIPTION OF THE FIGURES

FIG. 1 depicts an example a harvest yield prediction system, according to an embodiment.

FIG. 2 depicts the example implementation of the harvest yield prediction system of FIG. 1, according to an embodiment.

FIGS. 3A-B depict representations of pixels in an area of an aerial image according to an embodiment.

FIG. 4 depicts an example state diagram for generating a yield model according to an embodiment.

FIG. 5 depicts an illustrative embodiment of a general computer system for use with the disclosed embodiments.

FIG. 6 depicts a flow chart of an example method for yield prediction during harvesting of a field according to an embodiment.

FIG. 7 depicts a flow chart of an example method for yield prediction for a field according to an embodiment.

### DETAILED DESCRIPTION

Embodiments provide systems and methods for generating accurate predictive models for predicting yield of a field based on spatial yield data representing yield throughout the field and multiple measurements of actual yield obtained from multiple field regions in the field. The spatial yield data may be obtained from a yield measurement device, such as a yield monitor, used to measure yield during harvesting of the field. Additionally or alternatively, spatial yield data may be determined based on aerial imagery, such as satellite or drone imagery, depicting crop growth in the field. The multiple measurements of actual yield may be obtained by multiple yield weighing events throughout the field. For example, the weight of harvested crop may be determined each time a combine that harvests the field unloads collected crop from a container, such as a combine hopper, into another container, such as a grain cart or a truck. By associating such unloading events with the regions of the field from which the unloaded crop was harvested, multiple calibration equations may be determined and solved to relate the yield data obtained from yield monitor or aerial imagery data to the actual yield. A predictive model may thus be created that is more accurate than a calibration model that only utilizes a single total yield measurement for calibrating the spatial yield data for a field. This predictive model may then be used, for example as will be described, to predict machine fill levels and dispatch grain carts to unload operating combines so as to maximize machine utilization and optimize operating time so as to minimize machine idle time and the total time to harvest the field.

In at least some embodiments, using multiple yield weight measurements allows the system to dynamically construct and refine the yield model after commencement of harvesting of the field. Such a dynamically constructed model may be utilized to predict useful information in real time during harvesting of the field, such as the times and locations at which a container of harvesting machine, such as a combine, will fill up with harvested crop and will require unloading into another container, such as a grain cart container. This predicted information may then be used to ensure that a grain cart is dispatched at the predicted time and to the predicted location to allow for efficient combine unloading, e.g., avoid having to stop a full combine to await arrival of a grain cart to unload so harvest operations may continue, and optimize overall harvesting of the field. In some embodiments, aerial imagery data is utilized to further enhance accuracy of the model, by applying various corrections to yield monitor data, for example. These and other techniques described herein allow the system to provide more accurate yield maps as compared to conventional systems that utilize only a single weight measurement for calibration of spatial yield data and/or do not employ aerial data as a reference for correction of yield monitor data, and also allow for accurate real time predictions to be made during harvesting of the field to improve efficiency of harvesting operations.

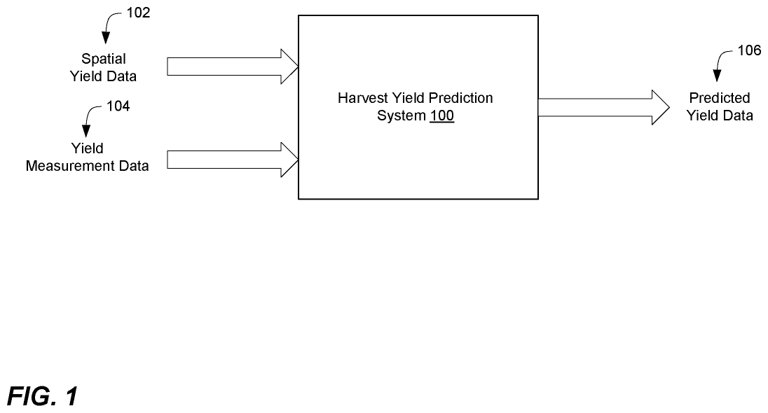

FIG. 1 is a block diagram depicting a harvest yield prediction system 100, according to an embodiment. The harvest yield prediction system 100 may be generally configured to obtain and process data related to yield of a crop, such as grain, corn, etc. in a field. The harvest yield prediction system 100 may be communicatively coupled, e.g., over a wired and/or wireless electronic communications network, to one or more pieces of equipment used for harvesting the field. For example, the harvest yield prediction system 100 may be communicatively coupled to yield monitors that may be attached to equipment used for harvesting the field, such as combine harvesters (sometimes referred to herein as simply “combines”) or other suitable types of harvesters that harvest the field. The harvest yield prediction system 100 may also be communicatively coupled to one or more weight measurement devices used to weigh the crop collected at various locations throughout the field, such as one or more scales that may be located on grain cart(s) used to unload the containers of the harvesting equipment, such as combines, as the containers fill up during harvesting of the field.

With continued reference to FIG. 1, the harvest yield prediction system 100 may receive a set of spatial yield data 102 and a set of yield measurements 104 and may determine predictive data 106 based on the set of spatial yield data 102 and the set of yield measurements 104. The set of spatial yield data 102 may comprise yield monitor data, such as data originating from a harvester-based yield monitor using force-plate, optical, or other technologies. Additionally or alternatively, the set of spatial yield data 102 may comprise data obtained from satellite or drone-acquired imagery such as normalized difference vegetation index (NDVI), enhanced vegetation index (EVI), normalized difference red edge (NDRE), or another optical vegetation index. Satellite imagery has the advantage of not requiring yield monitoring equipment to be installed on the harvester, and improved spatial resolution transverse to the direction of travel, as a yield monitor measures the yield of grain harvested by the entire width of the head or header. Further, because the combine header moves the crop transversely toward the harvester's feeder house, typically located at the middle of the header, the yield values represent an accumulation of a chevron-like shape, rather than a straight transverse line. Satellite imagery avoids these issues, as it directly observes the field from above, in at least some embodiments.

The set of yield measurements 104 may comprise weight measurements of yield collected throughout the field. In embodiments, a grain cart with an integrated scale system may be used to measure the total weight of grain harvested from a field. For example, the grain cart weight may be measured before and after each unload event, whereby the cart unloads into another machine such as a truck, and the total of such loads may be aggregated. Unloads, rather than fills, may be used to determine field totals, as the grain cart is generally stationary when unloading occurs, and this increases accuracy as opposed to using weights measured while in motion. The combine generally transfers material to (fills) the grain cart while in motion, as this minimizes the amount of the time the harvester is stopped, increasing efficiency. In an embodiment, by also detecting and measuring the grain cart weight before and after a fill event, the total amount of grain harvested by each combine may be determined and attributed to that combine, provided the identity of the combine for each fill is known. The identity of the combine may be selected manually by the operator(s) or automatically using proximity detection, machine alignment, time-aligned transfers, or any other method for detecting the pair of machines involved in the transfer. Further, if the path travelled by the harvester leading up to every fill is detected and recorded, the grain of each individual fill event may be associated with that specific region of a harvested field, provided the combine's storage hopper is fully unloaded for the fill event. If the hopper is not fully unloaded, multiple consecutive loads may need to be concatenated and their associated harvested areas concatenated so that the first region in the sequence begins with an empty hopper and the last region ends with an empty hopper. This ensures that the grain cart captures the weight of all the grain harvested in the aggregated region. What results is an array of field regions and corresponding totals rather than a single total and a single region, allowing for methods such as linear regression, machine learning or artificial neural networks to post calibrate the yield map much more accurately than previously disclosed methods. The grain cart fill (combine unload) weights for the area of field traversed by the combine may thus provide an accurate, low-resolution yield map consisting of irregular and interlocking tiles, where the average yield of each tile is known.

In an embodiment, the harvest yield prediction system 100 may be configured to determine a calibration model by using the weight of the combine loads as a reference, and solving for a calibration equation to relate the two datasets. The weight of combine loads may be measured by the increase in weight measured by a grain cart resulting from a transfer from the combine to the grain cart. If the location data of the combine as it harvests the field is also detected and recorded, either with dedicated global positioning system (GPS) data or with a mobile device such as a smartphone or tablet, then the weight can be directly associated with a specific subset of the field area. This area is represented by the locations recorded on the harvester prior to the current load and after the previous load, where locations already associated with a previous load are excluded. These excluded regions are necessary to account for areas of the field over which a combine passes more than once, such as the headlands at the edge of the field where the combine turns around after each pass. The total weight of grain represented by each section of the field can be represented by the following:

$${W}_{1} = \sum C ( {Y}_{1} ) + {ϵ}_{1} \\ {W}_{2} = \sum C ( {Y}_{2} ) + {ϵ}_{2} \\ {W}_{3} = \sum C ( {Y}_{3} ) + {ϵ}_{3} \\ ⋮ \\ {W}_{N} = \sum C ( {Y}_{N} ) + {ϵ}_{N} \qquad Equation 1$$

where W_{X} represents the measured weight of a combine unload, Y_{X} represents the associated uncalibrated spatial yield data, C(Y_{N}) represents the associated calibrated spatial yield data and ϵ_{X} represents the error between the predicted accumulated weight and the measured weight. If the calibration function is a linear combination of different operators, then the equations may be solved as an over-determined system of linear equations. For example, if the calibration equation takes the form C(Y)=β₀+β₁Y+β₂Y², then the follow matrices may be written:

$$[ \begin{matrix}{W}_{1} \\ {W}_{2} \\ {W}_{3} \\ ⋮ \\ {W}_{N}\end{matrix} ] = [ \begin{matrix}\sum 1 & \sum {Y}_{1} & \sum {Y}_{1}^{2} \\ \sum 1 & \sum {Y}_{2} & \sum {Y}_{2}^{2} \\ \sum 1 & \sum {Y}_{3} & \sum {Y}_{3}^{2} \\ ⋮ & ⋮ & ⋮ \\ \sum 1 & \sum {Y}_{N} & \sum {Y}_{N}^{2}\end{matrix} ] [ \begin{matrix}{β}_{0} \\ {β}_{1} \\ {β}_{2}\end{matrix} ] + [ \begin{matrix}{ϵ}_{1} \\ {ϵ}_{2} \\ {ϵ}_{3} \\ ⋮ \\ {ϵ}_{N}\end{matrix} ] \qquad Equation 2$$

The β vector represents the coefficients of the calibration function and may be determined using multiple regression matrix techniques, involving transpose and inversion operations. The matrix of summations of Y is referred to as the design matrix, X. This technique assumes the ε vector to be zero on average and ß may be determined as follows:

$$W = X β \qquad Equation 3$$

$${( {X}^{T} X )}^{- 1} {X}^{T} W = {( {X}^{T} X )}^{- 1} {X}^{T} X β \qquad Equation 4$$

$$β = {( {X}^{T} X )}^{- 1} {X}^{T} W \qquad Equation 5$$

The calibration equation may involve any operator, such as polynomials, exponentials, logarithms, trigonometric functions, lookup tables, etc., provided the predicted weight is a scaled linear combination of these operators, where the β vector represents the scaling factors. Once the coefficients are determined, a new design matrix, Z, may then be calculated using individual yield values rather than summed values. The computed β vector along with Z may now be used to predict the weight-based yield throughout the field as follows:

$${Y}_{c} = Z β \qquad Equation 6$$

This predictive model may then be used to predict the yield at each position within the field. Such data may be used for standard agronomic purposes such as prescription map generation, for example. In some embodiments, the predictive model may be used to predict real-time yields during harvesting of the field: such real-time yield predictions may be utilized to predict a time and/or location at which a harvester (e.g., a combine) hopper will have filled up during harvesting of the field. The time and/or location prediction may be utilized to dispatch another machine, such as a grain cart or a truck, to arrive at the predicted time to the predicted location for efficient unloading of the harvester hopper, for example. In an embodiment, the time and/or location predication may be transmitted to a computing device on the other machine and may be displayed to an operator of the other machine so that the operator of the other machine may travel to the appropriate location at the appropriate time for unloading of the combine hopper during harvesting of the field.

In an embodiment in which the set of spatial yield data 102 includes image data, such as satellite or drone image data containing vegetative reflectance information for the field, the harvest yield prediction system 100 may analyze the image data to generate a transform of the vegetative reflectance data into metrics related to aspects of the health of a crop in the field. For example, vegetative indices may be utilized to transform vegetative reflectance data into metrics related to various aspects of a plant's health, including biomass, nitrogen content, protein, starch, sugar, water, etc. Various methods that may be utilized by the harvest yield prediction system 100 to generate vegetative indices from pixel data of the images, according to some embodiments, are described in more detail below. As also described in more detail below, the harvest yield prediction system 100 may utilize the vegetative indices generated from image data of the field for calibrating and/or correcting yield data obtained from a yield monitor that may be attached to or otherwise integrated with a harvester used for harvesting the field. For example, the vegetative indices may be utilized to correct one or more of i) inaccuracies in yield monitor measurements resulting from orientation (e.g., pitch, roll, etc.) of the harvester, ii) spatial offset between the position of the crop in the field and the location as measured by the yield monitor during harvesting of the field, iii) a chevron effect caused by the finite speed of a conveyer of the combine harvesting the field and iv) inconsistencies in calibration parameters between multiple harvesters harvesting the field. Such corrections of yield monitor data allow for generation of a more accurate prediction model by the harvest yield prediction system 100 as compared to systems that do not use aerial imagery for yield monitor data corrections, in at least some embodiments.

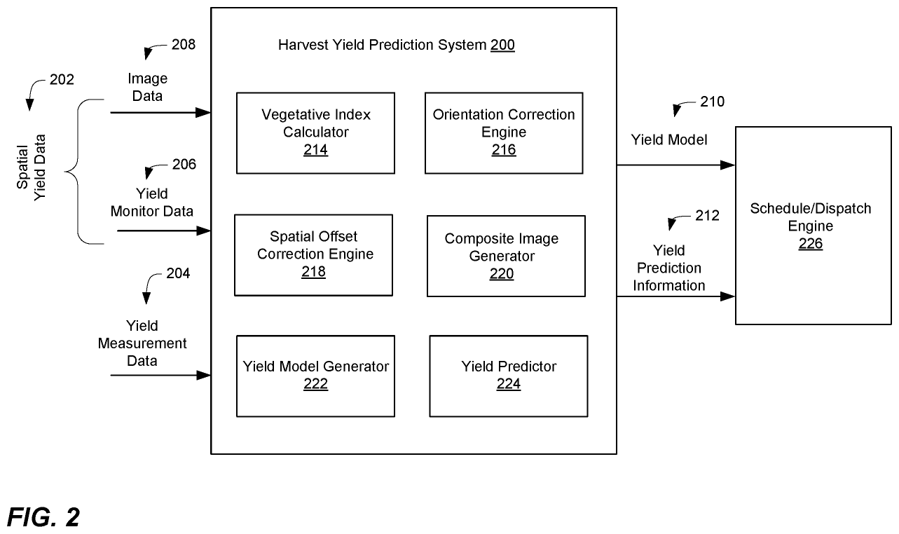

FIG. 2 depicts an example implementation of a harvest yield prediction system 200, according to an embodiment. The harvest yield prediction system 200 corresponds to the harvest data collection and harvest yield prediction system 100 of FIG. 1, in an embodiment. The harvest yield prediction system 200 is configured to receive a set of yield data 202 and yield measurement data 204. The set of yield data 204 may comprise data spatially representing yield throughout a field, such as yield monitor data 206 and/or aerial image data 208. The yield monitor data 206 may comprise signals received from a yield monitor device that may be associated with a combine harvesting the field and may comprise spatial measurements of amount (e.g., volume, mass, etc.) of harvested crop as the crop is being harvested in the field. The measurements of the amount of harvested crop may be associated with locations at which the crop is harvested throughout the field: such locations may be obtained from a positioning system (e.g., global positioning system (GPS)) that may be integrated with or otherwise provided on the combine harvesting the field. The aerial image data 208 may comprise one or more satellite or drone images, or data indicative thereof, also sometimes referred to “scans”, of the field during the growing season of the crop in the field. The yield measurement data 204 may comprise measurements of the actual yield obtained from the field. For example, the yield measurement data 204 may comprise weight measurements of the crop collected in the field, such as weight measurements obtained during unload events when the harvested crop is unloaded from the combine into another container, such as a grain cart, during harvesting of the field. The harvest yield prediction system 200 may generate a yield model 210 based on the set of yield data 202 and the yield measurement data 204. The harvest yield prediction system 200 may store the yield model 210 in a suitable data structure in a memory that may be included in, or otherwise accessible by, harvest yield prediction system 200. The stored yield model 210 may subsequently be utilized by the harvest yield prediction system 200 for making yield predictions. In an embodiment, the harvest yield prediction system 200 may utilize the yield model 210 to generate predictive information 212: such predictive information may comprise a yield map (e.g., in a suitable form such as a visualization of the geographic region corresponding to the field, a set of data points for the field, etc.), the yield at particular locations throughout the field, the location and/or time at which a harvesting machine, such as a combine, is expected to be at a predetermined fill level (e.g., full), etc., in various embodiments.

The harvest yield prediction system 200 includes a vegetative index calculator 214, an orientation correction engine 216, a spatial offset correction engine 218, a composite image generator 220, a yield model generator 222 and a yield predictor 224, in the illustrated embodiment. The harvest yield prediction system 200 may omit one or more of the vegetative index calculator 214, the orientation correction engine 216, the spatial offset correction engine 218, the composite image generator 220, the yield model generator 222 and the yield predictor 224, in other embodiments. The vegetative index calculator 214 may be configured to process aerial image data 208 and to generate vegetative indices based on pixel values in the aerial image data 208. Because the reflectance data is highly variable based on the intensity of incident light on the crop canopy, the vegetative index calculator 214 may normalize the measured spectra normalized based on the overall measurement of reflected light for the region being analyzed. A healthy plant absorbs blue and red optical wavelengths during photosynthesis, and reflects green wavelengths, giving rise to the plant's typically green color. Further, healthy plants reflect near-infrared light (NIR) even much more efficiently than green. As the biomass of the crop increases, the amount of reflected NIR increases. The health of the crop increases this reflectance further and decreases the reflectance of red wavelengths. Because increases in healthy biomass increases NIR reflection and decreases red reflection, various indices have been developed that are sensitive to the difference between these measurements as a proxy for biomass. The Difference Vegetation Index (DVI) is the arithmetic difference (NIR−Red), which directly measures the difference, but is sensitive to changes in radiation intensity. The Simple Ratio (SR) or Ratio Vegetation Index (RVI), is the ratio of NIR to Red (NIR/Red), which is less sensitive to atmospheric and radiance effects, as these are generally common to both bands and are effectively cancelled due to the ratio operation. However, the ratio may generate very large numbers when the red reflectance is low. The Normalized Difference Vegetation Index (NDVI) is the difference between NIR and Red (DVI) divided by the sum of NIR and Red (NIR−Red)/(NIR+Red). By normalizing the difference by the sum, one can account for changes in radiation intensity, but not atmospheric effects. This ratio is limited in range to −1 to +1, with positive numbers indicating the presence of vegetation. Because of its limited dynamic range, NDVI can suffer saturation effects at high levels of vegetation.

Various approaches to minimize this saturation may be utilized, generally relying on different scalars for the NIR and/or red components. However, the fundamental limitation with some vegetative indices, such as the NDVI-type normalization described above, is that each spatially-resolved indicator (pixel) is normalized by the same measurements used to determine the index. This limitation significantly attenuates the variability in biomass measured throughout a field, as each pixel is normalized in isolation.

In some embodiments, the vegetative index calculator 214 is configured to generate an improved vegetative index by normalizing all pixels within a given area of arbitrary shape by the same factor. This could be any value, though using certain values allows for comparison of data captured from different satellite passes, which may be required to create a composite image from multiple scans. As an example, the sum (NIR+Red) for each pixel in a field may be calculated and this data may be analyzed and reduced into a single value used to normalize the difference (NIR−Red) value for each pixel. This single value may be a maximum, aggregate sum, average, median, or any other statistical calculation based on the NIR+Red data. If this value is used as the normalizing denominator for every difference measurement within a field, the result is similar to NDVI, but is instead a linear function of DVI and, as such, is no longer bounded between −1 and +1 and avoids the saturation and comparison problems associated with standard NDVI, since each difference is scaled by the same normalizing factor.

A further enhancement to this method is to use one or more fixed pixel locations in each field as a common reference used for each image taken throughout the season. These pixels may be optimally chosen for each field or area such that they are highly visible in each image throughout the season, avoiding pixel locations affected by cloud cover or shadow. This technique allows for consistent normalization from image to image.

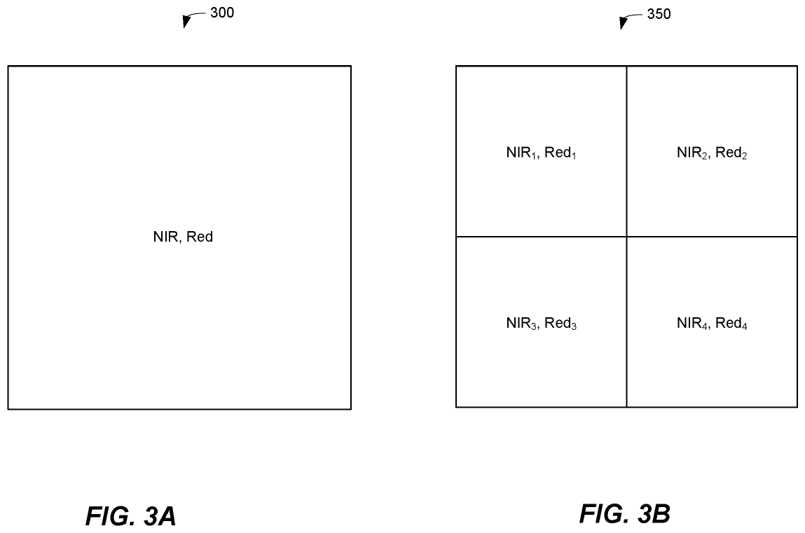

A specific implementation of the above improved method is to use the mean NIR+Red for a given area to normalize all NIR-Red measurements for the same area. The average of the difference measurements divided by the average of the sum measurements is equivalent to a single NDVI measurement for this same area using a single NIR and Red measurement. It may be observed that this is not equivalent to the average of the NDVI readings for each pixel constituting the area, which illustrates the problem of NDVI non-linearity. For example, referring briefly to FIGS. 3A-B, which depict image data for a same area of an image, where image data 300 in FIG. 3A is composed of a single pixel and pixel data 350 of FIG. 3B is composed of four pixels. To calculate an NDVI value using the single-pixel image 300 of FIG. 3A, only one NIR and one Red measurement is available, and NDVI would be calculated as the difference divided by the sum for both these measurements:

$${NDVI}_{S} = \frac{NIR - Red}{NIR + Red} \qquad Equation 7$$

Because the NIR and Red measurements both represent the total light measured for this entire area, it follows that reproducing this same calculation from higher resolution data must use the accumulation of NIR and Red readings for this same area. Therefore, the equivalent NDVI calculation using the multi-pixel data 350 of FIG. 3B should use the sum of each NIR and Red pixel value for the calculation:

$${NDVI}_{M} = \frac{\begin{matrix}{NIR}_{1} + {NIR}_{2} + {NIR}_{3} + {NIR}_{4} - \\ {Red}_{1} - {Red}_{2} - {Red}_{3} - {Red}_{4}\end{matrix}}{\begin{matrix}{NIR}_{1} + {NIR}_{2} + {NIR}_{3} + {NIR}_{4} + \\ {Red}_{1} + {Red}_{2} + {Red}_{3} + {Red}_{4}\end{matrix}} \qquad Equation 8$$

NDVI values for each pixel cannot be directly combined, as each pixel was normalized by a different factor. If the difference for each pixel is instead normalized by the average sum for the area, then the normalization is consistent and each modified NDVI reading may be directly (linearly) averaged to determine the NDVI for the area. For the example above, the four modified NDVI readings would be

$${NDVI}_{x} = \frac{4 ( {NIR}_{x} - {Red}_{x} )}{\begin{matrix}{NIR}_{1} + {NIR}_{2} + {NIR}_{3} + {NIR}_{4} + \\ {Red}_{1} + {Red}_{2} + {Red}_{3} + {Red}_{4}\end{matrix}} \qquad Equation 9$$

where x is 1, 2, 3 or 4 depending on the selected pixel. It may be observed by inspection that the average of these four modified NDVI readings would be equal to the single-pixel equivalent. These modified (linear) NDVI readings are not standard (non-linear) NDVI, however and, as such, are not confined to the −1 to +1 range. This expanded range allows for greater sensitivity under conditions of high vegetation, and its linearity affords greater suitability for regression techniques.

Referring again for FIG. 2, an alternative normalization method is to use a solar collector or reflector located such that it measures or reflects incoming light intensity representative of that incident upon the vegetation being measured. A solar collector may use photodetectors to measure the intensity of received light at one or more wavelengths, and these measurements may be used to normalize the difference readings. The intensity measurements may be logged to internal storage of the collector device and manually transferred to another system, or the measurements may be communicated those measurements via satellite, cellular, Wi-Fi, or other wireless or wired communications technology. A reflector may be constructed with a highly reflective material such that incident solar radiation may be reflected and observed by the same satellite measurements observing the vegetation. It may be designed to reflect many wavelengths, or a small number. The reflected light will be visible in the resulting satellite image, and the magnitude of this measurement used to normalize the other measurements.

This consistent normalization factor for a field also provides opportunities to employ other techniques for analyzing and comparing the normalized spectral data within a field or geographic area. For example, this spectral data may be transformed into a set of orthogonal dimensions through techniques such as principal component analysis (PCA). For instance, the consistently-normalized blue, green, red and NIR data may be analyzed using PCA to determine the orthogonal components whereby the variance in each component is maximized.

By transforming the prediction data to align with each new dimension, or a subset of dimension with maximum variance, the transformed data may then be used to predict the biomass using regression techniques. This combination of PCA, data transformation and regression is referred to as principal component regression (PCR). As discussed, PCA separates the predictive data into dimensions defined by maximum variance; however, these new dimensions are not necessarily optimized to explain the most variance of the desired prediction. Another similar method which may be utilized is partial least squares regression (PLS). PLS also transforms the data into orthogonal dimensions, except the transformation dimensions are chosen to maximize the correlation between the predictive data and the response data instead of maximizing the variance of the predictive data in isolation. As PLS considers the response data as well as the predictive data, it is a supervised process, whereas PCR is unsupervised, and therefore the PLS method may be preferred when response data is available.

With continued reference to FIG. 2, the vegetative indices obtained from satellite or drone imagery by the vegetative index calculator 214 may be used as a reference for calibrating/correcting the yield monitor data. A number of issues commonly found with yield monitors, such as inaccuracy due orientation of the machine (e.g., combine) that includes sensors (e.g., compression plate) for providing yield measurements for the yield monitor, spatial offset between the position of the crop in the field and location as measured by the yield monitor, etc., may be corrected by using this type of imagery as a reference. For example, the harvest yield prediction system 200 may employ the orientation correction engine 216 to correct yield monitor inaccuracy due to machine orientation. Because the pitch or roll of the harvester can affect the signal generated by the yield sensor, slopes may reduce the accuracy of the yield data. If an accelerometer is located in the combine, such as when contained in a mobile device in the machine's cab, the accelerometer data may be utilized to detect and collect the orientation of the machine as it harvests the field. By determining a frequency histogram for the imagery vegetative index level with a given vegetative index bin size, the yield data may be grouped by expected yield based on the vegetative index so that any variations in yield monitor output within the bin should be due to changes in machine orientation. Because this controls for yield, a regression analysis may then be performed for the data represented for each bin, where the yield sensor signal is adjusted as a function of machine angle in both pitch and roll. The function may be linear, polynomial, trigonometric such as by using a cosine function, or any other relationship. The coefficients across bins may be averaged or otherwise combined to generate an overall relationship between pitch, roll, and yield sensor gain. The yield map may be then adjusted by correcting for this using the measured transformation function.

Additionally or alternatively, the harvest yield prediction system 200 may employ the spatial offset correction engine 218 to correct the spatial offset between the position of the crop in the field and location as measured by the yield monitor. Because of the time it takes for the grain to travel through the combine before being measured by the yield sensor, a spatial offset results, determined by the combine's direction of travel and its speed multiplied by this delay. One method for detecting the spatial offset is to shift the yield data in space by varying amounts, performing a cross correlation of the satellite data and each shifted yield dataset, and selecting the shift resulting in the maximum cross correlation. The overall offset is determined by shifting the yield dataset spatially by varying amounts in either direction along the harvester's path of travel, and selecting the offset resulting in the largest cross correlation with the satellite imagery. Because the harvester typically travels back and forth, this will cause the yield values to be shifted different directions depending on their respective locations in the field. Additionally, as this is a direct spatial offset, it does not account for variations in speed. However, as combines travel generally at the same speed in a given field, the cross correlation solution represents the offset most representative of the dataset overall. After this adjustment, the spatial offset may by further adjusted by accounting for the machine's speed. If a frequency histogram of the machine speed during harvesting is performed with a given speed bin size, the center of the most frequent speed bin (mode) may be chosen as the speed associated with the cross correlation result. The delay through the harvester may then be determined by dividing the spatial offset (distance) by this speed. The yield map may then be spatially resampled by positionally shifting yield points by the measured delay multiplied by the combine speed, opposite to the direction of travel. This data is the effective header conveyer delay plus the threshing delay before the grain reaches the yield sensor, which is typically located in the clean grain elevator.

The cross correlation-based spatial offset method described above does not account for the chevron effect caused by the finite header conveyer speed. Though cross correlation-based methods are well-suited to detecting delays between signals with high levels of noise and distortion, the accuracy of this measurement may be further improved by accounting for this effect while performing the cross correlation. One way to accomplish this is to upconvert the satellite image to a high-resolution image using techniques such as linear, sinc, Lanczos, or bi-cubic interpolation. A combine may be modeled as a transverse, spatial integration function with a delay, where the integration represents the accumulation of the satellite imagery data over the combine header width, using a variable-angle chevron. The ground speed and header conveyor speed determine the chevron angle with respect to a transverse line, with the angle being the tangent of the machine speed divided by the conveyer speed. Faster machine speeds increase the angle and faster conveyor speeds decrease it. Therefore, a synthesized yield monitor signal may be generated by spatially integrating the upconverted satellite image using the header width and a dynamically-determined chevron shape based on the instantaneous harvester speed and an assumed header conveyor speed, creating a single yield value for each combine position within the field. This signal may be then cross-correlated with the actual yield monitor data, with the maximum cross-correlation associated with the detected spatial offset between the two. If this process is repeated for various assumed header conveyor speeds over the expected conveyor speed range of industry-standard headers, the optimum header conveyor speed may be determined by selecting the maximum cross correlation overall. This approach works even if the combine is harvesting a swath, as it will detect the speed of the canvas on a swather or windrower. The accuracy may be further improved by accounting for the width of the feeder house, or swather opening, as the grain harvested directly in front of this component travels directly into the machine, avoiding any delay due to transverse motion. This shape is equivalent to a chevron, but with flattened vertex.

Referring still to FIG. 2, acquired aerial image data 208 may have undesired artifacts, such as cloud cover or shadows, the shadows often being caused by the cloud cover, in some embodiments. For example, the cloud cover may occlude (with thick clouds) or attenuate (with thin clouds) the spectral information from the image, and shadows may also cause reduced spectral readings. The harvest yield prediction system 200 may employ the composite image generator 220 to compensate for such artifacts by constructing a composite image from multiple images, with these images preferably captured as close in time to one another as is possible. One method for processing these images is to threshold each pixel, comparing each index value to a minimum threshold, such that pixels with too low an index value due to cloud cover or lack of biomass are excluded. The threshold for each pixel location may be statically determined from the complete imagery set, or dynamically determined using a frequency histogram of the index values for a given location across the imagery set, and performing outlier rejection based on the minimum of the contiguous portion of the distribution. The pixels surviving the thresholding process for each location may be averaged together, and the set of all averages may be used to construct a composite image free of artifacts. The number of images required for this process may be variable, with additional images added until at least one measurement for each location is acquired.

The yield monitor generator 222 may be configured to utilize corrected yield monitor data and the yield measurement data 204 to generate the yield model 210 as described above with reference to FIG. 1. For example, the yield monitor generator 222 may construct and solve a set of equations such as Equation 1 as described above to generate a model such as the model described above with reference to Equation 6. The yield monitor generator 222 may be configured to store the yield model 210 in a suitable data structure in a memory that may be included in the harvest yield prediction system 200 or otherwise accessible by the harvest yield prediction system 200. The yield predictor 224 may be configured to utilize the yield model 210 that may be stored in the memory to generate predictive information 212: such predictive information may comprise a yield map for the field, the yield at particular locations throughout the field, the location and/or time at which a harvesting machine, such as a combine, is expected to be at a predetermined fill level (e.g., full), etc., in various embodiments. In some embodiments, the yield model 210) and/or the yield prediction information 212 may be provided to a scheduler/dispatch engine 226 that may be included in or otherwise accessible by the harvest yield prediction system 200. The scheduler/dispatch engine 226 may utilize the yield model 210 and/or the yield prediction information 212 for harvesting optimization operations, such as for dispatching equipment, such as grain carts, to a particular combine so as to arrive at or just before the predicted time of the combine's hopper being full and ready to unload, etc. In some embodiments, the scheduler/dispatch engine 226 may generate and transmit an indicator to a smart device or a computing device in a cab of the combine and/or other equipment (e.g., a machine, such as a tractor, that pulls a grain cart) that may inform an operator pulling the grain cart of the predicted time and the location at which the hopper of the combine is expected to be full, for appropriately positioning the grain cart, for example. In some embodiments, the scheduler/dispatch engine 226 may generate and transmit an indicator to a computing device in a cab of the a tractor pulling a grain cart, for example, to inform the driver when and where to go.

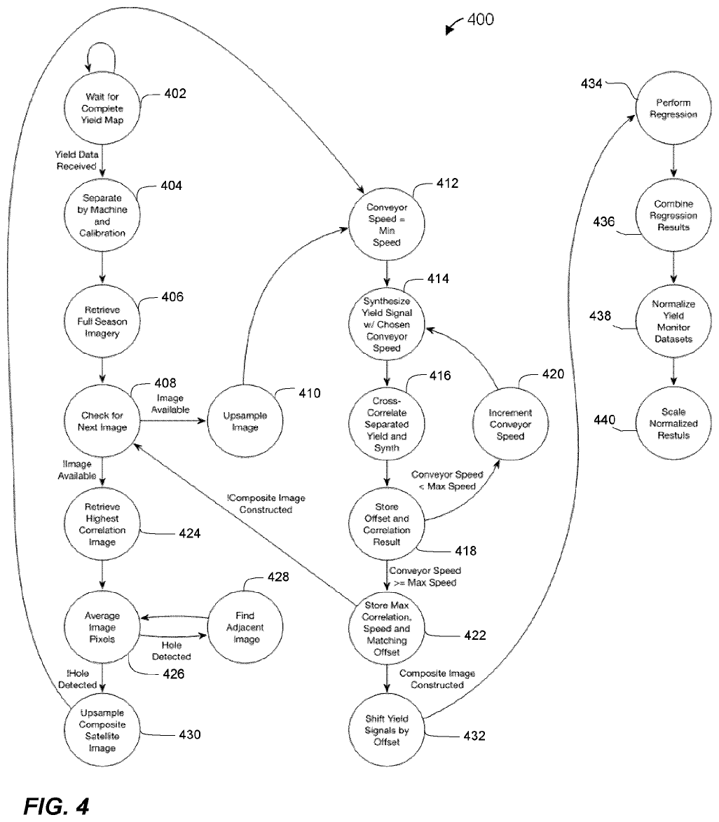

Referring now to FIG. 4, the overall approach may be implemented using a state machine 400. The state machine 400 may be implemented by the harvest yield prediction system 100 of FIG. 1 or the harvest yield prediction system 200 of FIG. 2, in some embodiments. The state machine 400 is initialized in a Waiting for Complete Yield Map state 402, where data from yield monitors in a given field is received. When yield data from all yield monitors in the field is received, the state machine 400 transitions to a Separate by Machine and Calibration state 404, where the yield data is separated by yield monitor, and is further separated within each monitor by calibration factor to account for calibration changes. The state machine 400 then transitions to a Retrieve Full Season Imagery state 406, where all chronological satellite imagery corresponding to the yield data for the growing season is collected. The state machine 400 next transitions to a Check for Next Image state 408, where the next image in the full season, starting with the first, is read.

If an image is available, the state machine 400 transitions to Upsample Image 410 where the satellite image is upconverted to a higher resolution. Next, the state machine 400 transitions to a Conveyor Speed=Min Speed state 412, where the conveyor speed is initialized to the minimum expected conveyor speed for the combine header. The state machine 400 then transitions to a Synthesize Yield Signal with Chosen Conveyor Speed state 414, where a virtual yield signal is synthesized for the current satellite image and conveyor speed. The result of this is cross-correlated with each of the associated yield monitor data sets in a Cross-Correlate Separated Yield and Synth state 416. The resulting offsets and correlation results are then stored in a Store Offset and Correlation Result state 418. If the conveyor speed is less than the maximum conveyor speed, the conveyor speed is incremented in an Increment Conveyor Speed state 420 and the state machine 400 then transitions back to the Synthesize Yield Signal with Chosen Conveyor Speed state 414.

Referring back to the Store Offset and Correlation Result state 418, if the conveyor speed is at the maximum speed, the state machine 400 then transitions to a Store Max Correlation, Speed and Matching Offset state 422, where the maximum correlation, speed, and associated offset for each of the yield monitor datasets is found and stored. The state machine 400 then transitions back to Check for Next Image 408. If an image is available, the state machine 400 again transitions to the Upsample Image state 510. Otherwise, if no more images are available, the state machine 400 transitions to a Retrieve Highest Correlation Image state 424, in which the satellite image with the highest combined cross-correlation results across yield monitor and calibration datasets is selected. As the measured vegetative index is correlated with the amount of green biomass, the index values will increase throughout the growth phase of the plant and then decrease as the plant matures. The maximum cross-correlation therefore generally coincides with the image associated with the maximum vegetative health of the crop, measured as a vegetative index.

The state machine 400 then transitions to an Average Image Pixels state 426, where the average vegetative index for each pixel location across the imagery for the full crop season is calculated. Each pixel is then compared to its corresponding average, and because the pixel should be the maximum for the season, a vegetative index lower than the average indicates a non-vegetative hole in the image due to cloud cover or some other anomaly. Instead of using the average as the threshold, a threshold based on a number of standard deviations above the average may be used instead. If a hole is detected in this state, an adjacent image in the time-ordered set is selected in a Find Adjacent Image state 428 such that the maximum vegetative index for the same pixel location is found, and this index value will be substituted for the hole detected in the highest correlation image previously selected. This process will continue until no holes remain in the composite image. Because the maximum vegetative index may occur on different days for different portions of the field, due to differences in planting or seeding dates or rainfall variation in different parts of the field, a composite image using the maximum for each pixel location may be instead used.

After the composite image is constructed, the state machine 400 transitions to the Upsample Composite Satellite Image state, where the hole-free composite image is upsampled in Upsample Composite Satellite Image, and this composite image is cross-correlated with the yield monitor signals by transitioning again to the Conveyor Speed=Min Speed state 412. Once the conveyor speeds, offsets and correlation results are again found with the composite image, the yield monitor signals are each shifted by the offsets detected in the cross-correlations in a Shift Yield by Offset state 432, such that they align with the satellite imagery. The state machine 400 then transitions to the Perform Regression state 434, where a regression between the synthesized yield signal and the shifted yield monitor dataset from each combine and calibration combination is performed. The results of each regression are then combined in a Combine Regression Results state 436. If linear regression is used, the coefficients from each regression may be averaged, and the averages of each coefficient represents a combined regression model. This may use a direct arithmetic average, or a weighted average, weighted by the number of data points in the relevant dataset, the area covered by each dataset, or some other metric.

The state machine 400 then transitions to a Normalize Yield Monitor Datasets state 438, where each yield monitor dataset is normalized by using its associated regression model and the combined regression result. In the case of linear regression, this may be performed by predicting a vegetative index value from each yield monitor subset using its associated regression model. The normalized yield monitor data may then be determined by using this complete, predicted vegetative index dataset and the combined regression model and solving for the corresponding yield monitor data by running the combined regression model in reverse. This results in a complete yield map, where the datasets from multiple yield monitors are matched, accounting for calibration inconsistencies. This map may then be finally adjusted in a Scale Normalized Results state 440, such that the field total from the synthesized monitors matches the total as measured by a grain cart scale, truck scale, or grain terminal scale.

In some embodiments, the method described above may use a combination of low cost or free imagery in conjunction with higher-resolution paid imagery. For example, the low cost/free imagery may be utilized to find a date corresponding to maximum vegetative index values, and then paid imagery corresponding to those same day's may retrieved to avoid searching the more expensive imagery for the optimal days.

The synthesized yield monitor signal described above may also be used to predict the combine hopper fill level, by integrating with time the field regions harvested since last unloading. This provides a real-time estimate of each combine's fill level, improving logistics. Additionally, it also allows for predicting the location where the harvester will be full by extrapolating a given harvester path, and the time the harvester will be full based on extrapolating the average speed.

If the model for a field is developed using satellite imagery and grain cart or yield monitor data, it may be developed and refined as the field is harvested. Each combine load weight (from a yield monitor or grain cart) and associated satellite data may be provided to the model as they become available, affording the ability to optimize harvest operations by predicting the yield of to-be-harvested areas of the field. This prediction accuracy increases as the number of loads and corresponding harvested area increases. Because the path of the harvesters can be predicted and the speed assumed, the estimate of yield along that path may be utilized to predict a real-time estimate of each combine's fill level, and further predict when and where the combine will be full. This information may then be directed to the grain cart operator, so they know when and where each harvester will be full, minimizing guesswork and allowing the grain cart to wait at the correct location for unloading. This information may be further used to optimize the unload order of each harvester based on knowledge of the grain cart location, maximizing the efficiency of the grain cart, and minimizing fuel consumption, allowing for significant financial savings. Further, by knowing where the bin yard is and the grain auger size, the round-trip time may be modelled and a forward-looking harvest schedule developed, continually adapted as harvest progresses. As harvest proceeds and the grain cart load data or yield monitor data is used with the imagery to develop a yield prediction model as described above, the model may be utilized to predict the yield of unharvested areas of the same crop type based on the imagery alone. The accuracy of this prediction model increases as harvest unfolds and more grain cart data or yield monitor data is collected. This allows for predicting the yield and quantity of grain from fields not yet harvested, allowing for forecasting storage requirements, and forward selling grain with more confidence. Further, it may also be possible to analyze satellite imagery to divide a field into multiple zones of similar expected yield, as this should also correlate with similar quality. By harvesting these zones separately and segregating the grain, it allows for the opportunity to blend grain to maximize the economics.

The previously described calibration process relying on grain cart events uses cart fill events, rather than unload events, as fill events outnumber unload events, providing more data for generation of the yield model. The approximate average ratio between the number of cart fills versus cart unloads is the ratio of the average combine hopper size for combines harvesting in the field to the average grain cart tank size for grain carts in that same field. For example, if there are three combines with 400-bushel hoppers serviced by a single grain cart with a capacity of 1200 bushels, there will be roughly three times as many load events than unload events. This allows the yield model to converge more quickly if load events are used, though unload events may be sufficient. The yield model may rely on data collected from multiple fields, as this further increases the quantity of data available for determining the model. Because a satellite image represents a snapshot of the crop during its growth cycle, the yield model should be generated from images of the same growth stage for the crop. If the crops are planted closely in time to one another, within a few days, then images taken on the same day will be compatible with the model. If the crops are planted further apart, then a time offset between images selected may be used, where a later image is used for later-planted crop and an earlier image is used for an earlier-planted crop. As discussed, images will often be taken under conditions of cloud cover and shadow, and this requires selection of one or more different days in order to find a complete cloud-free and shadow-free image or construct a cloud-free image from sections of multiple images not containing cloud cover. Though unload events are generally outnumbered by load events, they are generally more accurate as the grain cart is typically stationary when they occur. Therefore, calibration accuracy can be improved by pre-scaling each combine unload (grain cart fills) weight by the ratio of the sum of all cart unload weights for a region over the sum of all combine unload weights (grain cart fills) for that same region. Alternatively, the yield data may be corrected by the fill events and then subsequently scaled by the total as measured by the unload events. Both of these techniques relies on the assumption that weight of grain harvested from all combines operating on a field equals the total unloaded from the grain cart for that same field. This may not be true in cases where the grain cart changes fields with grain still in the cart. In the case that a non-empty grain cart leaves a field, the amount of grain may be measured and allocated to the field being left. Any unload events recorded in the subsequent field may be allocated to the previous field until the excess weight of grain is depleted, after which the weight of grain may be allocated to the subsequent field. These corrected totals may then be used to further adjust the yield data.

Yield maps are typically represented as a horizontal planar surface, which ignores any topographical features relating to changes in elevation. These elevation changes can significantly affect yield as low spots accumulate more moisture than high spots. Further, the slope of the terrain can cause the accuracy of yield monitor to be impaired. Increased moisture leads to higher yields in normal or dry conditions, but lower yields in wet conditions as excess moisture can promote plant disease. Elevation and spatial data may be combined to create a digital elevation model, from which a flow accumulation model may be generated, mapping the relative variation of moisture accumulation within the field. By including the slope, elevation, and flow accumulation data into the analysis, the described yield calibration process can be further improved.

This data may be acquired from external data sources of digital elevation models, or directly measured from sensors installed on the harvester, such as GPS, accelerometers, altimeters, barometers, etc. These sensors may be supported directly on the harvester, or via a mobile device installed in the harvester's cab, where that mobile device contains one or more of these sensors. As the harvester travels throughout the field, the mobile device may collect location, speed, and direction of travel data via its GPS subsystem, and elevation data via GPS, altimeters or barometers, and accelerometer readings.

The flow accumulation model may be directly determined from the accelerometer and GPS location (latitude/longitude) without requiring elevation information. A flow accumulation model divides a field into pixels, and determines how many upstream pixels flow into each pixel based on the direction of flow for each pixel. The flow direction for each pixel may be determined directly by the accelerometer from the horizontal components of the measured tilt direction. Further, the vertical component of the tilt may be used to weight the amount of the flow, with a steeper tilt representing higher flow than a lower tilt. The flow weight may be further influenced by the porosity of the soil, with more porous soils such as sand having a lower weight than less porous soils such as clay. The flow accumulation map, combined with one or more vegetative indices, yield monitoring data, or any other yield-predicting data may then be analyzed and compared with the reference weights collected from the grain cart. Because many of these predictors may be correlated with one another, the predictors may need to be separated into independent components using methods such as principal component analysis, which create independent (orthogonal) variables. Because the independent components are uncorrelated, the predicted yield may be modelled as a linear combination of each component, so multiple regression analysis may be performed using the principal components rather than using the predictors directly. The regression is then similar to that described above, except the design matrix and coefficient vector contain one or more values corresponding to each independent component. For instance, if three independent components are used and a second order polynomial is used for the model, then there will be seven coefficients in the coefficient vector, and seven values in each row of the design matrix.

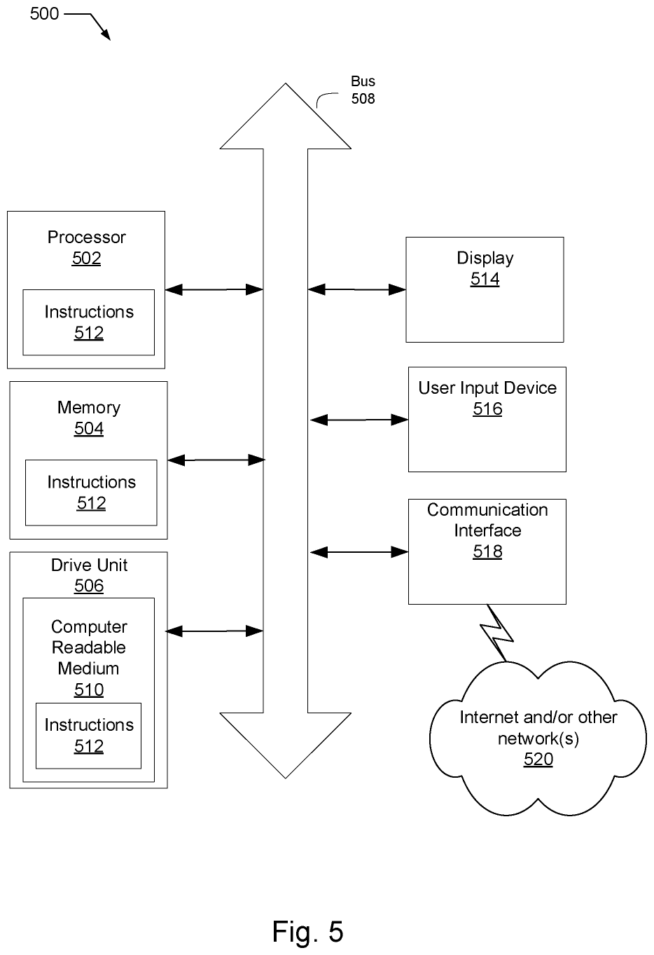

Referring now to FIG. 5, an illustrative embodiment of a general computer system 500 is shown which may be used to implement the disclosed embodiments or one or more components thereof. The computer system 500 can include a set of instructions that can be executed to cause the computer system 500 to perform any one or more of the methods or computer-based functions disclosed herein. The computer system 500 may operate as a standalone device or may be connected, e.g., using a network, to other computer systems or peripheral devices. Any of the components discussed herein, such as processor 502, may be a computer system 500 or a component in the computer system 500. The computer system 500 may be specifically configured to implement the harvest yield prediction system 100 or the harvest yield prediction system 200 as described herein.

In a networked deployment, the computer system 500 may operate in the capacity of a server or as a client or user computer in a client-server user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics processing unit (GPU), or both. The processor 502 may be a component in a variety of systems. For example, the processor 502 may be part of a standard personal computer or a workstation. The processor 502 may be one or more general processors, digital signal processors, specifically configured processors, application specific integrated circuits, field programmable gate arrays, servers, networks, digital circuits, analog circuits, combinations thereof, or other now known or later developed devices for analyzing and processing data. The processor 502 may implement a software program, such as code generated manually or via an artificial intelligence (i.e., programmed).

The computer system 500 may include a memory 504 that can communicate via a bus 508. The memory 504 may be a main memory, a static memory, or a dynamic memory. The memory 504 may include, but is not limited to, computer readable storage media such as various types of volatile and non-volatile storage media, including but not limited to random access memory, read-only memory, programmable read-only memory, electrically programmable read-only memory, electrically erasable read-only memory, flash memory, ferro-magnetic random access memory, magnetic tape or disk, optical media and the like. In one embodiment, the memory 504 includes a cache or random access memory for the processor 502. In alternative embodiments, the memory 504 is separate from the processor 502, such as a cache memory of a processor, the system memory, or other memory. The memory 504 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 504 is operable to store instructions executable by the processor 502. The functions, acts or tasks illustrated in the figures or described herein may be performed by the programmed processor 502 executing the instructions 512 stored in the memory 504. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 500 may further include a display unit 514, such as a liquid crystal display (LCD), an organic light emitting diode (OLED), e-paper display, a flat panel display, a solid state display, a cathode ray tube (CRT), a projector, a printer or other now known or later developed display device for outputting determined information. The display 514 may act as an interface for the user to see the functioning of the processor 502, or specifically as an interface with the software stored in the memory 504 or in the drive unit 506.

Additionally, the computer system 500 may include an input device 516 configured to allow a user to interact with any of the components of system 500. The input device 516 may be a number pad, a keyboard, an accelerometer (or other detector of physical movement), a voice control/input device, or a cursor control device, such as a mouse, or a joystick, touch screen display, remote control or any other device operative to interact with the system 500.

In a particular embodiment, as depicted in FIG. 5, the computer system 500 may also include a disk or optical drive unit 506. The disk drive unit 506 may include a computer-readable medium 510 in which one or more sets of instructions 512, e.g., software, can be embedded. Further, the instructions 512 may embody one or more of the methods or logic as described herein. In a particular embodiment, the instructions 512 may reside completely, or at least partially, within the memory 504 and/or within the processor 502 during execution by the computer system 500. The memory 504 and the processor 502 also may include computer-readable media as discussed herein.

The present disclosure contemplates a computer-readable medium that includes instructions 512 or receives and executes instructions 512 responsive to a propagated signal, so that a device connected to a network 520 can communicate voice, video, audio, images or any other data over the network 520. Further, the instructions 512 may be transmitted or received over the network 520 via a communication interface 518. The communication interface 518 may be a part of the processor 502 or may be a separate component. The communication interface 518 may be created in software or may be a physical connection in hardware. The communication interface 518 is configured to connect with a network 520, external media, the display 514, or any other components in system 500, or combinations thereof. The connection with the network 520 may be a physical connection, such as a wired Ethernet connection or may be established wirelessly. Likewise, the additional connections with other components of the system 500 may be physical connections or may be established wirelessly.

The network 520 may include wired networks, wireless networks, or combinations thereof. The wireless network may be a cellular telephone network, an 802.11, 802.16, 802.20, or WiMax network. Further, the network 520 may be a public network, such as the Internet, a private network, such as an intranet, or combinations thereof, and may utilize a variety of networking protocols now available or later developed including, but not limited to, TCP/IP based networking protocols.

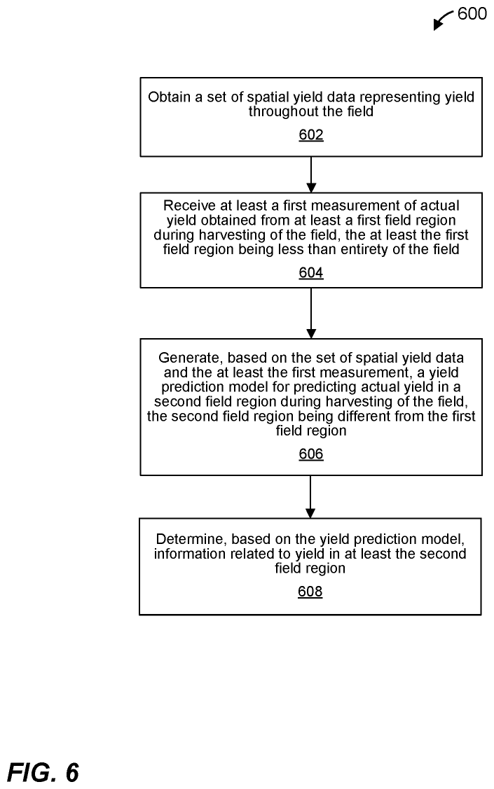

Referring now to FIG. 6, a flow chart of an example method 600 for yield prediction during harvesting of a field is illustrated according to an embodiment. The method 600 may be implemented by the harvest yield prediction system 100 of FIG. 1 and/or the harvest yield prediction system 100 of FIG. 2, in an embodiment. The method 600 may be implemented by a system different from the harvest yield prediction system 100 of FIG. 1 and/or the harvest yield prediction system 100 of FIG. 2, in other embodiments. In embodiments, the method 600 may be implemented by the computer system 500 of FIG. 5 or by a suitable computer system different from the computer system 500 of FIG. 5.

At block 602, a set of spatial yield data representing yield throughout the field is obtained. The set of spatial yield data may comprise one or both of aerial image data depicting crop growth in the field and yield monitor data from harvesting the field. In an embodiment, the set of spatial yield data 102 of FIG. 1 or the set of spatial yield data 202 of FIG. 2 is obtained. In other embodiments, other suitable sets of spatial yield data is obtained. In an embodiment, the set of spatial yield data is obtained during harvesting of the field, subsequent to commencement of harvesting of the field. In another embodiment, the set of spatial yield data is obtained after completion of harvesting of the field.

At block 604, at least a first measurement of actual yield obtained from at least a first field region during harvesting of the field, the at least the first field region being less than entirety of the field. For example, at least a first yield measurement of crop unloaded from a combine container is received. The at least the first yield measurement may include a crop weight measurement in association with identification (e.g., coordinate data) defining the corresponding at least first field region in which the crop was harvested. In an embodiment, yield measurement data 104 of FIG. 1 or the yield measurement data 204 of FIG. 2 is received. In other embodiments, suitable yield measurement data different from the yield measurement data 104 of FIG. 1 or the yield measurement data 204 of FIG. 2 is received.

At block 606, a yield prediction model is generated based on the set of spatial yield data obtained at block 602 and the at least the first measurement received at block 604. The yield prediction model is for predicting actual yield in a second field region during harvesting of the field, the second field region being different from the first field region. The yield prediction model may be generated as described above. For example, a system of multiple equations may be generated and solved as described above with reference to FIG. 1. In an embodiment, the yield prediction model 210 of FIG. 2 is generated. In another embodiment, a suitable yield prediction model different from the prediction model 210 of FIG. 2 is generated. In an embodiment, the state diagram 400 of FIG. 4 may be implemented to generate the yield prediction model. In an embodiment, the yield prediction model may be stored in a memory for subsequent use. In some embodiments, the yield prediction model may be subsequently refined based on further yield measurement(s) that may be received during harvesting of further regions of the field.

At block 608, information related to yield in at least the second field region is determined based on the yield prediction model generated at block 606. For example, one or both of a time and a location corresponding to a predetermined fill level of a container of a harvester used for harvesting the at least the second field region is determined. This predicted time and/or location may be utilized to dispatch other equipment, such as grain carts, to unload operating combines so as to maximize machine utilization and optimize operating time so as to minimize machine idle time and the total time to harvest the field, for example. As another example, a calibrated yield map for the field is determined.

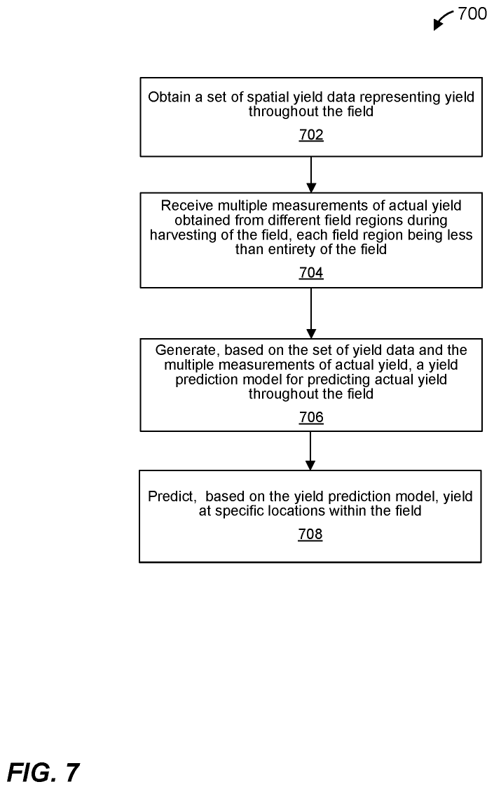

Referring now to FIG. 7, a flow chart of an example method 700 for yield prediction for a field is illustrated according to an embodiment. The method 700 may be implemented by the harvest yield prediction system 100 of FIG. 1 and/or the harvest yield prediction system 100 of FIG. 2, in an embodiment. The method 700 may be implemented by a system different from the harvest yield prediction system 100 of FIG. 1 and/or the harvest yield prediction system 100 of FIG. 2, in other embodiments. In embodiments, the method 700 may be implemented by the computer system 500 of FIG. 5 or by a suitable computer system different from the computer system 500 of FIG. 5.

At block 702, a set of spatial yield data representing yield throughout the field is obtained. The set of spatial yield data may comprise one or both of aerial image data depicting crop growth in the field and yield monitor data from harvesting the field. In an embodiment, the set of spatial yield data 102 of FIG. 1 or the set of spatial yield data 202 of FIG. 2 is obtained. In other embodiments, other suitable sets of spatial yield data is obtained.

At block 704, multiple measurements of actual yield are obtained from different field regions during harvesting of the field, each field region being less than entirety of the field. For example, multiple measurements of crop unloaded events from a combine container is received. The multiple measurements may include crop weight measurements in association with respective identifications (e.g., coordinate data) defining the corresponding field regions over which the crop was harvested. In an embodiment, yield measurement data 104 of FIG. 1 or the yield measurement data 204 of FIG. 2 is received. In other embodiments, suitable yield measurement data different from the yield measurement data 104 of FIG. 1 or the yield measurement data 204 of FIG. 2 is received.

At block 706, a yield prediction model is generated based on the set of spatial yield data obtained at block 702 and the multiple yield measurements received at block 704. The yield prediction model is for predicting actual yield throughout the field. The yield prediction model may be generated as described above. For example, a system of multiple equations may be generated and solved as described above with reference to FIG. 1. In an embodiment, the yield prediction model 210 of FIG. 2 is generated. In another embodiment, a suitable yield prediction model different from the prediction model 210 of FIG. 2 is generated. In an embodiment, the state diagram 400 of FIG. 4 may be implemented to generate the yield prediction model. In an embodiment, the yield prediction model may be stored in a memory for subsequent use.

At block 708, yield at specific locations within the field is predicted based on the yield prediction model generated at block 706. For example, a yield map for the field is generated. This yield map may be utilized for developing a precision agriculture program for subsequent planting and growing season(s) in the field, for example.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated or otherwise specifically configured hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, ferro-magnetic memory, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

As used herein, the terms “microprocessor” or “general-purpose processor” (“GPP”) may refer to a hardware device that fetches instructions and data from a memory or storage device and executes those instructions (for example, an Intel Xeon processor or an AMD Opteron processor) to then, for example, process the data in accordance therewith. The term “reconfigurable logic” may refer to any logic technology whose form and function can be significantly altered (i.e., reconfigured) in the field post-manufacture as opposed to a microprocessor, whose function can change post-manufacture, e.g. via computer executable software code, but whose form, e.g. the arrangement/layout and interconnection of logical structures, is fixed at manufacture. The term “software” may refer to data processing functionality that is deployed on a GPP. The term “firmware” may refer to data processing functionality that is deployed on reconfigurable logic. One example of a reconfigurable logic is a field programmable gate array (“FPGA”) which is a reconfigurable integrated circuit. An FPGA may contain programmable logic components called “logic blocks”, and a hierarchy of reconfigurable interconnects that allow the blocks to be “wired together”, somewhat like many (changeable) logic gates that can be inter-wired in (many) different configurations. Logic blocks may be configured to perform complex combinatorial functions, or merely simple logic gates like AND, OR, NOT and XOR. An FPGA may further include memory elements, which may be simple flip-flops or more complete blocks of memory.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well. Feedback provided to the user can be any form of sensory feedback, e.g., visual feedback, auditory feedback, or tactile feedback. Input from the user can be received in any form, including acoustic, speech, or tactile input.

Embodiments of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

Herein, the phrase “coupled with” is defined to mean directly connected to or indirectly connected through one or more intermediate components. Such intermediate components may include both hardware and software-based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions here before or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations may include distributed processing, component/object distributed processing, and parallel processing. Alternatively, virtual computer system processing may be constructed to implement one or more of the methods or functionalities as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in the specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

As used in the application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory (ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry.” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a GPS receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The memory may be a non-transitory medium such as a ROM, RAM, flash memory, etc. The processor and the memory may be supplemented by, or incorporated in, special purpose logic circuitry.

To provide for interaction with a user, embodiments of the subject matter described in this specification may be implemented on a device having a display, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments of the subject matter described in this specification may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the subject matter described in this specification, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

1. A computer implemented method for yield prediction during harvesting of a field, the method comprising:
obtaining, by a processor, a set of spatial yield data representing yield throughout the field;
receiving, by the processor, at least a first measurement of actual yield obtained from at least a first field region during harvesting of the field, the at least the first field region being less than entirety of the field;
generating, by the processor based on the set of spatial yield data and the at least the first measurement, a yield prediction model for predicting actual yield in a second field region during harvesting of the field, the second field region being different from the first field region, and storing the yield prediction model in a memory coupled with the processor; and
determining, by the processor based on the yield prediction model stored in the memory, information related to yield in at least the second field region.

2. The method of claim 1, wherein determining information related to the at least the second field region comprises determining one or both of a time and a location corresponding to a predetermined fill level of a container of a harvester used for harvesting the at least the second field region.

3. The method of claim 2, further comprising transmitting, with the processor, the time and the location corresponding to the predetermined fill level of the container of the harvester to a computing device located in a machine other than the harvester to cause the one or both of the time and the location to be displayed to an operator of the machine other than the harvester and to dispatch the machine other than the harvester to arrive at the time and to the location for unloading the container of the harvester.

4. The method of claim 1, wherein receiving the at least the first measurement of actual yield obtained from at least the first field region during harvesting of the field comprises receiving a weight measurement of a crop harvested from the first field region during harvesting of the field.

5. The method of claim 1, wherein obtaining the set of spatial yield data representing yield throughout the field comprises receiving one or both of aerial image data depicting crop growth in the field and yield monitor data from harvesting the field.

6. The method of claim 5, wherein
obtaining the set of spatial yield data representing yield throughout the field comprises receiving both of aerial image data depicting crop growth in the field and yield monitor data from harvesting the field, and
generating the yield prediction model includes correcting yield monitor data from harvesting the field using aerial image data depicting crop growth in the field as a reference for yield in the field.

7. The method of claim 6, wherein correcting yield monitor data from harvesting the field includes correcting the yield monitor data for one or both of inaccuracies due to orientation of the harvester at a time of collection of the yield monitor data in the field and a spatial offset between a position of a crop in the field and a location as measured by the yield monitor during harvesting of the field.

8. The method of claim 1, wherein
receiving the at least the first measurement of actual yield obtained from at least a first field region during harvesting of the field comprises receiving multiple measurements of yield obtained from multiple field regions during harvesting of the field, and
generating the yield prediction model includes solving a set of multiple equations relating respective ones of multiple measurements of actual yield with data in the in the set of spatial yield data representing yield in corresponding regions of the field.

9. The method of claim 1, wherein
obtaining the set of spatial yield data representing yield throughout the field comprises receiving aerial image data depicting crop growth in the field, and
the method further comprises calculating vegetative indices based on pixel values of the aerial image data depicting crop growth in the field, including normalizing a plurality of pixels within a particular image region by a same factor.

10. A system for yield prediction during harvesting of a field, the system comprising:
a processor, and
a memory coupled to the processor, the memory storing computer readable instructions that, when executed by the processor, cause the processor to:
obtain a set of spatial yield data representing yield throughout the field,
receive at least a first measurement of actual yield obtained from at least a first field region during harvesting of the field, the at least the first field region being less than entirety of the field,
generate, based on the set of spatial yield data and the at least the first measurement, a yield prediction model for predicting actual yield in a second field region during harvesting of the field, the second field region being different from the first field region, and
determine, based on the yield prediction model, information related to yield in at least the second field region.

11. The system of claim 10, wherein the computer readable instructions, when executed by the processor, cause the processor to determine one or both of a time and a location corresponding to a predetermined fill level of a container of a harvester used for harvesting the at least the second field region.

12. The system of claim 11, wherein the computer readable instructions, when executed by the processor, cause the processor to cause the time and the location corresponding to the predetermined fill level of the container of the harvester to be transmitted to a computing device located in a machine other than the harvester to cause the one or both of the time and the location to be displayed to an operator of the machine other than the harvester and to dispatch the machine other than the harvester to arrive at the time and to the location for unloading the container of the harvester.

13. The system of claim 10, wherein the computer readable instructions, when executed by the processor, cause the processor to receive a weight measurement of a crop harvested from the first field region during harvesting of the field.

14. The system of claim 10, wherein the computer readable instructions, when executed by the processor, cause the processor to receive one or both of aerial image data depicting crop growth in the field and yield monitor data from harvesting the field.

15. The system of claim 14, wherein the computer readable instructions, when executed by the processor, cause the processor to
receive both of aerial image data depicting crop growth in the field and yield monitor data from harvesting the field, and
correct yield monitor data from harvesting the field using aerial image data depicting crop growth in the field as a reference for yield in the field.

16. The system of claim 15, wherein the computer readable instructions, when executed by the processor, cause the processor to correct the yield monitor data for one or both of inaccuracies due to orientation of the harvester at a time of collection of the yield monitor data in the field and a spatial offset between a position of a crop in the field and a location as measured by the yield monitor during harvesting of the field.

17. The system of claim 10, wherein the computer readable instructions, when executed by the processor, cause the processor to
receive multiple measurements of yield obtained from multiple field regions during harvesting of the field, and
generate the yield prediction model at least by solving a set of multiple equations relating respective ones of multiple measurements of actual yield with data in the set of spatial yield data in corresponding regions of the field.

18. The system of claim 10, wherein the computer readable instructions, when executed by the processor, cause the processor to
receive aerial image data depicting crop growth in the field, and
calculate vegetative indices based on pixel values of the aerial image data depicting crop growth in the field, including normalizing a plurality of pixels within a particular image region by a same factor.

19. A computer implemented method for yield prediction for a field, the method comprising:
obtaining, by a processor, a set of spatial yield data representing yield throughout the field;
receiving, by the processor, multiple measurements of actual yield obtained from different field regions during harvesting of the field, each field region being less than entirety of the field;
generating, by the processor based on the set of yield data and the multiple measurements of actual yield, a yield prediction model for predicting actual yield throughout the field, and storing the yield prediction model in a memory coupled with the processor; and
predicating, by the processor based on the yield prediction model stored in the memory, yield at specific locations within the field.

20. The method of claim 19, wherein receiving the multiple measurements of actual yield comprises receiving multiple weight measurements of a crop harvested from the different field regions during harvesting of the field.

21. The method of claim 19, wherein obtaining the set of spatial yield data representing yield throughout the field comprises receiving one or both of aerial image data depicting crop growth in the field and yield monitor data from harvesting the field.

22. The method of claim 19, wherein generating the yield prediction model includes solving a set of multiple equations relating respective ones of the multiple measurements of actual yield with data in the set of spatial yield data representing yield in corresponding regions of the field.

23. A system for yield prediction during harvesting of a field, the system comprising
means for obtaining a set of spatial yield data representing yield throughout the field;
means for receiving at least a first measurement of actual yield obtained from at least a first field region during harvesting of the field, the at least the first field region being less than entirety of the field;
means for generating, based on the set of spatial yield data and the at least the first measurement, a yield prediction model for predicting actual yield in a second field region during harvesting of the field, the second field region being different from the first field region; and
means for determining, based on the yield prediction model, information related to yield in at least the second field region.
